(19) United States
(12) Patent Application Publication
(10) Pub. No.: US 2014/0205203 A1
(43) Pub. Date: Jul. 24, 2014

(54) System and Method for Visual Correlation of Digital Images

(71) Applicant: University of Central Florida Research Foundation, Inc., Orlando, FL (US)

(72) Inventors: Stephanie Lackey, Orlando, FL (US); Joseph Fanfarelli, Port Orange, FL (US); Eric Ortiz, Deltona, FL (US); Daniel Barber, Orlando, FL (US)

(73) Assignee: University of Central Florida Research Foundation, Inc., Orlando, FL (US)

(21) Appl. No.: 14/161,155

(22) Filed: Jan. 22, 2014

Related U.S. Application Data
(60) Provisional application No. 61/755,172, filed on Jan. 22, 2013.

(51) Int. Cl. G06K 9/62

(52) U.S. Cl. CPC G06K 9/6201
USPC 382/278

(57) ABSTRACT

The present invention provides a quantitative, automated system and method for assessing the correlation level of two rendered images, thereby removing subjectivity from such evaluation. The objective metric of the present invention determines whether two static images are correlated enough to be undetectable by a human observer. The performance of this method is optimized based upon the capabilities and limitations of the human visual system. Therefore, the resulting assessments are not overly sensitive and reduce the resources required to assess rendered images within a networked simulation environment. Additionally, the simplicity of the method lends itself to implementation within existing and emerging simulation systems with relatively little effort compared to current assessment methods. The system and method of the present invention provide benefits to multiple organizations, such as those engaged in human-in-the-loop simulators, distributed learning, and training applications.

### CROSS REFERENCE TO RELATED APPLICATIONS

This application is a Non-Provisional of co-pending U.S. provisional Application No. 61/755,172, filed Jan. 22, 2013, which is incorporated herein by reference.

STATEMENT OF GOVERNMENT INTEREST

This invention was made with government support under the U.S. Army Research, Development and Engineering Command #W91CRB08D0015. The government has certain rights in the invention.

### BACKGROUND OF THE INVENTION

The military training community utilizes Simulation-Based Training (SBT) to close the gap between classroom-based and live training. SBT typically includes some combination of live (e.g., real tanks and dismounted infantry), virtual (e.g., a live soldier interacting with a tank simulator) and constructive (e.g., fully or semi-autonomous simulated tanks) entities. FIG. 1 illustrates a typical LVC (Live, Virtual, Constructive) network architecture. The Local Area Network (LAN), at the core of the architecture, reaches out to all other elements. Live assets operating on the range may be integrated per training requirements. Virtual assets representing individual (and group were applicable) roles performed on simulated platforms (e.g., communications, fire support) may also be integrated. Semi-Automated Forces (SAP) systems providing constructive friendly and enemy entities may be included in the LVC. Instructor support tools such as a master control station and After-Action Review (AAR) console(s) may additionally be linked to control, observe, and debrief training events. As shown in FIG. 1, the LAN connects local assets to distributed sites via a long haul network gateway. The complex interaction between LVC training elements requires careful planning, implementation, and execution. Interoperability plays a central role in the success of SBT and LVC training.

The primary sensory cue indicator in a visual system simulation is the fidelity or “look” of the environment. Due to the importance of fidelity, understanding the levels of interoperability a system maintains is imperative. Interoperability, succinctly defined, is the ability of multiple systems to find a common ground or work together in a coupled environment. Standardization designs across simulators have been developed to support interoperation. However, the differences in individual image generation software (e.g., rendering engines, polygonalization, thinning) of various manufacturers makes it difficult to produce a standardized “fidelity” between applications. Furthermore, proprietary application information is a key factor that limits standardization due to individual manufacturers permitting database correlation or synthesis, but prohibiting uniform image generation processes.

Traditionally, correlation and interoperability between two simulation systems is determined by Terrain Database (TDB) correlation methods and/or human visual inspection. TDB correlation chooses random, corresponding points within the TDB and then performs a numeric comparison(s). However, there are limitations to using these prior art methods. TDB correlation does not assess the images generated, but instead utilizes the underlying data created by image generators. Therefore, differing, often proprietary, polygonalization, thinning and rendering algorithms are used, and the differences in hardware and software capabilities are excluded from TDB comparisons. Therefore, what a trainee sees may be very different between two image generators. The direct comparison of generated images generated is performed by human inspection and is employed in one of two ways. The first involves the use of a side-by-side viewer to subjectively inspect a particular location of interest. Alternatively, in human visual inspection, a human observer may view several, co-located simulation platforms simultaneously to subjectively determine if the visuals presented on each computer display are correlated. However, neither of these approaches objectively measures the rendered images presented to the trainee, nor do they fully explore automated assessment capabilities.

Anecdotal evidence from the SBT and LVC communities indicates a need to extend the efforts of terrain database correlation to visual correlation. For example, two trainees performing a ground exercise within the same simulator have been located in close proximity within simulated terrain at the same time and have not experienced the same visual scene. FIG. 2A and FIG. 2B demonstrate the type of differences described by soldiers: (1) differing brightness levels and (2) mountains appearing on one trainee's console (FIG. 2A), but not the other (FIG. 2B). This may prove problematic if entities arrive on the scene from the horizon or with general coordination and situation awareness when soldiers interact solely through radio communications.

Moreover, it is important to acknowledge the global impact of poor correlation within the LVC paradigm. A trainee operating a virtual asset that communicates with a trainee on the range, must also be able to rely upon the validity of his/her visual display to ensure fair fight, as well as safety.

Accordingly, what is needed in the art is a system and method capable of objectively assessing rendered images in an automated fashion.

### SUMMARY OF INVENTION

The present invention provides a quantitative, automated system and method for assessing the correlation level of two rendered images. Thus, it removes subjectivity from such evaluation. The method of the present invention has been calibrated using results from human-in-the-loop experimentation. The performance of this method is optimized based upon the capabilities and limitations of the human visual system. Therefore, the resulting assessments are not overly sensitive and reduce the resources required to assess rendered images within a networked simulation environment. Additionally, the simplicity of the method lends itself to implementation within existing and emerging simulation systems with relatively little effort compared to current assessment methods.

The objective metric of the present invention determines whether two static images are correlated enough to be undetectable by a human observer. The measurement algorithm developed is suitable for implementation in software. The system and method of the present invention provide benefits to multiple organizations, such as those engaged in human-in-the-loop simulators, distributed learning, and training applications.

### BRIEF DESCRIPTION OF THE DRAWINGS

For a fuller understanding of the invention, reference should be made to the following detailed description, taken in connection with the accompanying drawings, in which:

FIG. 1 is a diagram illustrating a typical LVC Network Architecture.

FIG. 2A is a first sample landscape including mountains and FIG. 2B is a second sample landscape omitting mountains.

FIG. 3 is a frequency chart illustrating an experimental average HITL (Human-in-the-loop) correlation assessment levels.

FIG. 4 is a table showing an experimental sample of average HITL correction levels for image pairs.

FIG. 5A is a first sample landscape including mountains, separated into partitions and

FIG. 5B is a second sample landscape omitting mountains, separated into partitions.

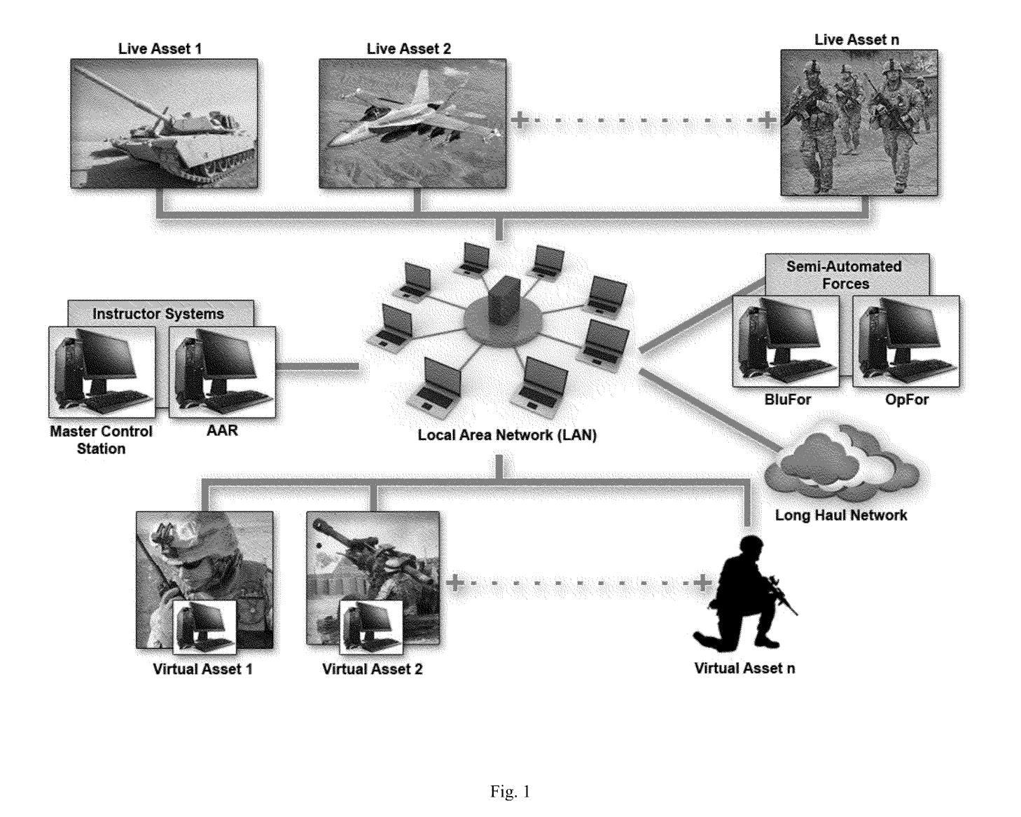

### DETAILED DESCRIPTION OF THE INVENTION

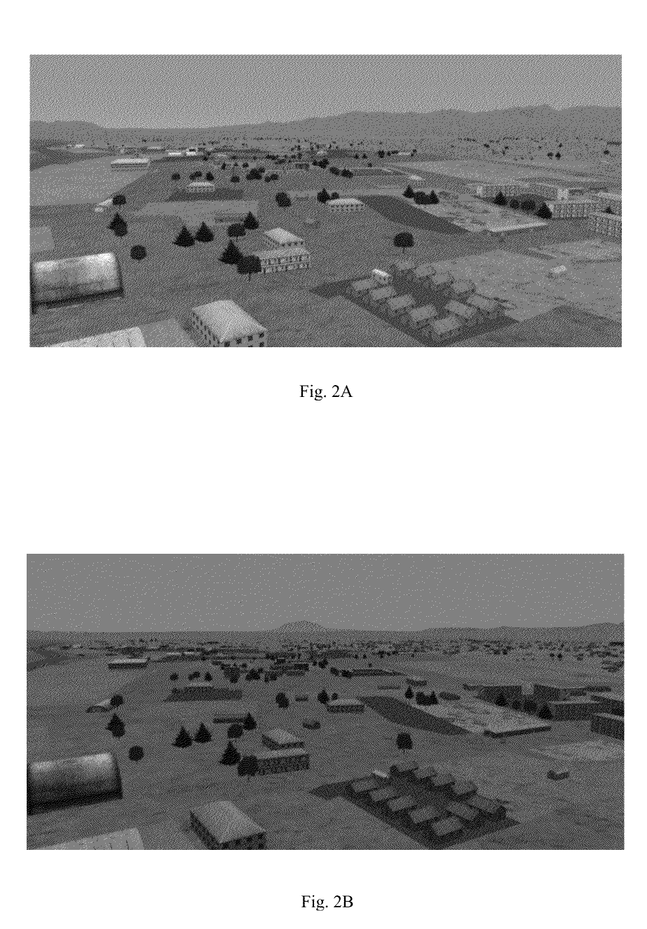

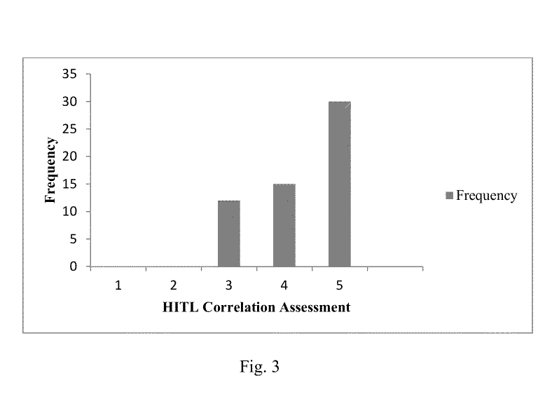

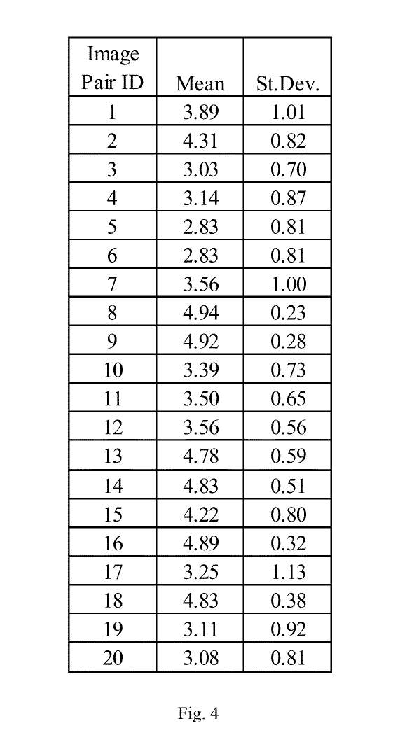

In order to baseline visual correlation thresholds based on the human visual system, a Human-In-The-Loop (HITL) experiment was conducted. The stimuli consisted of several dozen pairs of images from a variety of military simulation systems. Each pair of images was generated on two consoles at the same time and same location with the same terrain database (see FIGS. 2A and 2B). Participants were asked to rate the level of correlation on a scale of 1 to 5, with 5 indicating perfect correlation. The chart presented in FIG. 3 shows summary statistics in the form of a frequency chart of the average correlation level for each of the 57 image pairs presented as assessed by human participants. The chart shows that on average participants found the image pairs to be at least somewhat correlated (i.e., rating of 3). The table presented in FIG. 4 shows the mean correlation level and standard deviation for 20 of the image pairs presented to participants.

These results were used to develop a threshold for acceptable correlation and compared based on two different automated methods. The first method compared the images at the pixel level and the second separated each image into a minimum of 30 partitions (to support statistical analyses). The comparative results were used to develop a minimum threshold metric for image correlation that is presented below. The objective of developing the metric presented is to facilitate the development of a draft standard that can be evaluated via automated means rather than requiring a subjective human assessment. The objective metric of the present invention determines whether two static images are correlated enough to be undetectable by a human observer. The measurement algorithm developed is suitable for implementation in software.

Based upon the empirical research conducted, the following calculation describes an objective assessment of visual correlation calibrated by the human visual system. This formulation represents a method to determine visual correlation between two static images that can be implemented without human intervention.

Given that two images (such as the images in FIGS. 2A and 2B) Image1 and Image2 are each divided into a matrix of corresponding pixel squares of the following dimensions (height×width): 49×49 or 23×23, then for C≧0.49, Image1 and Image2 are considered correlated, such that:

$${Δ}_{i} = \vert {I}_{( x , y ) 1} - {I}_{( x , y ) 2} \vert$$

$${Δ}_{i} \leq 1 -> {C}_{i} = 1$$

$${Δ}_{i} > 1 -> {C}_{i} = 0$$

$$C = \frac{{\sum }_{i = 1}^{n} Ci}{N}$$

Where C=percent correlation between two images

Ci=percent correlation between two partitions

Δi=difference between luminance values for image pair i

l(x,y)=luminance value for partition (x,y)

N=number of partitions

In essence, if at least 49% of the average luminance values of the partitions for a given pair of images are correlated, then the two images can be considered correlated.

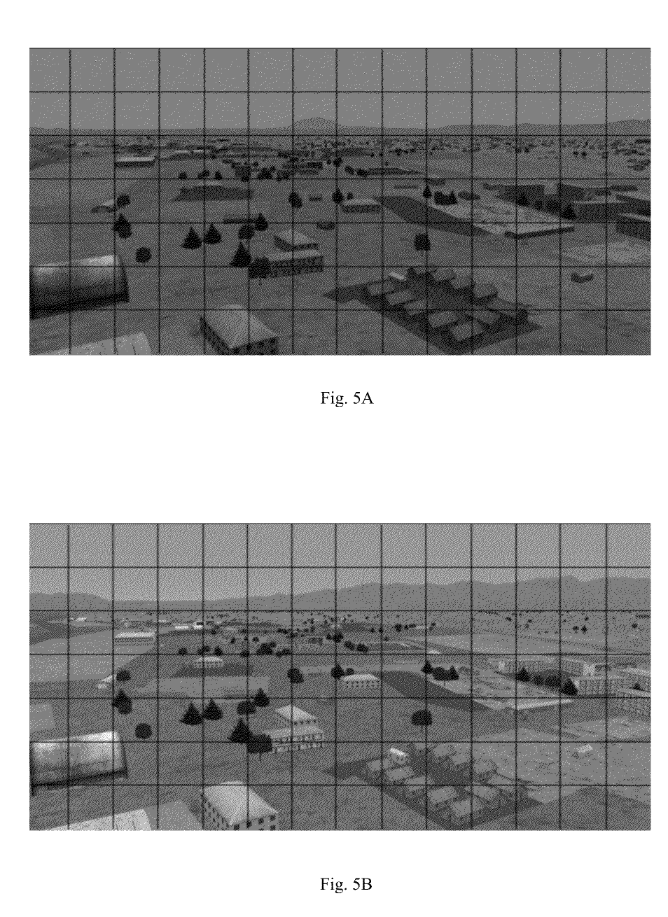

In an exemplary embodiment, the images of FIGS. 2A and 2B are divided into equal sized partitions based on number of pixels, as shown with reference to FIGS. 5A and 5B.

After partitioning the images into blocks of pixels, the average luminance in each block is calculated by calculating the luminance values for all the pixels in the block and then finding the average luminance of each partition.

The difference between the average luminance value of each block of Image1 is compared to the average luminance value of the associated block of Image2 and if a difference is detected, the percent correlation between the two blocks is assigned a value of “1”. If a difference is not detected between the two blocks, the percent correlation between the two blocks is assigned a value of “0”.

After each of the blocks in the two images have been compared to each other, an average of the percent correlation of the individual blocks is calculated to determine the overall percent correlation between the two images.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A system and method for assessing the correlation level of two rendered images.
